(19) United States
(12) Patent Application Publication
(10) Pub. No.: US 2023/0326278 A1
(43) Pub. Date: Oct. 12, 2023

(54) DISTRIBUTED PLATFORM FOR PROCESSING CONCURRENT, THREAD-SAFE REQUESTS

(71) Applicant: Lottobot LLC, Chicago, IL (US)

(72) Inventors: Aleksandar Videnovic, Chicago, IL (US); Matthew Christopher Wilborne, Chicago, IL (US); John Karl Muellner, Park Ridge, IL (US); Charles Edward McElvenny, Wilmette, IL (US)

(21) Appl. No.: 17/716,718

(22) Filed: Apr. 8, 2022

(51) Int. Cl. G07C 15/00; G07F 17/32

(52) U.S. Cl. CPC G07C 15/005; G07F 17/329; G07C 15/006; G06Q 50/34

(57) ABSTRACT

Aspects described herein relate to queuing and processing ticket objects associated with combinations of numbers to enforce a process of elimination for a ticket event. A ticket array for a ticket event may be generated. The ticket array may comprise a plurality of combinations of numbers consisting of combinations of unprocessed numbers and combinations of processed numbers. A ticket object associated with the ticket event may be received from a client computing device. The ticket object may comprise a combination of selected numbers that are added to a ticket queue. There may be a determination of whether the ticket object meets ticket criteria. In response to the ticket object meeting at least one of the ticket criteria, the ticket object may be processed. A notification may be generated after the ticket object has been processed. Furthermore, the notification may be sent to the client computing device.

### FIELD OF USE

Aspects of the disclosure relate generally to systems for processing procurement requests for a gaming platform. More specifically, aspects of the disclosure may provide for the use of queues to facilitate transactions to procure tickets for a gaming platform.

### BACKGROUND

Computing systems and applications may be used to process various forms of data used by users of a gaming platform. Ideally, these computing devices and applications will process the data used by the gaming platform in an efficient and secure manner, thereby preserving the integrity of the gaming platform. However, the interplay of different systems and applications can be complex and may result in suboptimal processing, which may in turn result in lower efficiency of resource usage, redundancies (e.g., users selecting the same game choices) in data generated by users of the game platform, and lower player satisfaction. As a result there exists a demand for a way to more effectively process data for a game platform such that resource usage is improved and redundancy of user selected game choices is minimized.

### SUMMARY

Aspects of the disclosure address one or more of the drawbacks mentioned above by disclosing methods, computer readable media, and apparatuses associated with a gaming platform that processes ticket objects as disclosed herein.

More particularly, some aspects described herein may include a computer-implemented method of queuing and processing ticket objects associated with combinations of numbers to enforce a process of elimination for a ticket event, the computer-implemented method comprising: generating, by a server computing system comprising one or more processors, a ticket array based on parameters of the ticket event, wherein the ticket array comprises a plurality of combinations of numbers consisting of a plurality of combinations of processed numbers for the ticket event and a plurality of combinations of unprocessed numbers for the ticket event; receiving, by the server computing system, and from a client computing device, a ticket object associated with the ticket event, wherein the ticket object comprises a combination of selected numbers; adding, by the server computing system, the ticket object to a ticket queue that is configured to hold the ticket object before the ticket object is processed; determining, by the server computing system, whether the ticket object meets ticket criteria comprising a ticket criterion associated with a uniqueness of the combination of selected numbers for the process of elimination for the ticket event; in response to the ticket object meeting at least one of the ticket criteria, processing, by the server computing system, the ticket object, wherein the processing comprises: determining whether one or more queue locking criteria have been met, wherein the one or more queue locking criteria comprises a threshold number of ticket objects; in response to determining that at least one of the one or more queue locking criteria have been met, locking the ticket queue, wherein the locking the ticket queue prevents any ticket object from being added to the ticket queue until one or more queue unlocking conditions have been met; updating the ticket array with the combination of selected numbers, wherein the updating comprises storing the combination of selected numbers in the ticket array; updating the ticket object to indicate that the ticket object can be removed from the ticket queue; determining whether one or more queue unlocking conditions have been met, wherein the one or more queue unlocking conditions comprise a rate of adding ticket objects to the ticket queue being below a rate threshold; in response to at least one of the one or more queue unlocking conditions being met, unlocking the ticket queue after updating the ticket object; generating, by the server computing system, a notification after the ticket object has been processed; and sending, by the server computing system, the notification to the client computing device.

According to some aspects, one or more non-transitory computer readable media may comprise instructions that, when executed by at least one processor, cause a computing device to perform operations comprising: generating a ticket array based on parameters of a ticket event, wherein the ticket array comprises a plurality of combinations of numbers consisting of a plurality of combinations of processed numbers for the ticket event and a plurality of combinations of unprocessed numbers for the ticket event; receiving from a client computing device, a ticket object associated with the ticket event, wherein the ticket object comprises a combination of selected numbers; adding the ticket object to a ticket queue that is configured to hold the ticket object before the ticket object is processed; determining whether the ticket object meets ticket criteria comprising a ticket criterion associated with a uniqueness of the combination of selected numbers for a process of elimination for the ticket event; in response to the ticket object meeting at least one of the ticket criteria, processing the ticket object, wherein the processing comprises: determining whether one or more queue locking criteria have been met, wherein the one or more queue locking criteria comprises a threshold number of ticket objects; in response to determining that at least one of the one or more queue locking criteria have been met, locking the ticket queue, wherein the locking the ticket queue prevents any ticket object from being added to the ticket queue until one or more queue unlocking conditions have been met; updating the ticket array with the combination of selected numbers, wherein the updating comprises storing the combination of selected numbers in the ticket array; updating the ticket object to indicate that the ticket object can be removed from the ticket queue; determining whether one or more queue unlocking conditions have been met, wherein the one or more queue unlocking conditions comprise a rate of adding ticket objects to the ticket queue being below a rate threshold; in response to at least one of the one or more queue unlocking conditions being met, unlocking the ticket queue after updating the ticket object; generating a notification after the ticket object has been processed; and sending the notification to the client computing device.

Furthermore, according to some aspects, a computing system may comprise: one or more processors; and memory storing instructions that, when executed by the one or more processors, cause the computing system to: generate a ticket array based on parameters of a ticket event, wherein the ticket array comprises a plurality of combinations of numbers consisting of a plurality of combinations of processed numbers for the ticket event and a plurality of combinations of unprocessed numbers for the ticket event; receive from a client computing device, a ticket object associated with the ticket event, wherein the ticket object comprises a combination of selected numbers; add the ticket object to a ticket queue that is configured to hold the ticket object before the ticket object is processed; determine whether the ticket object meets ticket criteria comprising a ticket criterion associated with a uniqueness of the combination of selected numbers for a process of elimination for the ticket event; in response to the ticket object meeting at least one of the ticket criteria, process the ticket object, wherein the processing comprises: determine whether one or more queue locking criteria have been met, wherein the one or more queue locking criteria comprises a threshold number of ticket objects; in response to determining that at least one of the one or more queue locking criteria have been met, lock the ticket queue, wherein the locking the ticket queue prevents any ticket object from being added to the ticket queue until one or more queue unlocking conditions have been met; update the ticket array with the combination of numbers, wherein the updating comprises storing the combination of numbers in the ticket array; update the ticket object to indicate that the ticket object can be removed from the ticket queue; determine whether one or more queue unlocking conditions have been met, wherein the one or more queue unlocking conditions comprise a rate of adding ticket objects to the ticket queue being below a rate threshold; in response to at least one of the one or more queue unlocking conditions being met, unlock the ticket queue after updating the ticket object; generate a notification after the ticket object has been processed; and send the notification to the client computing device.

Aspects of the disclosure address one or more of the issues mentioned above by disclosing methods, computer readable media, devices, systems, and apparatuses. In one example, the system may involve method steps disclosed herein. With another aspect of the disclosure, a system may communicate with a data store as disclosed herein.

Aspects of the disclosure may be provided in a computer-readable medium having computer-executable instructions to perform one or more of the process steps described herein.

This summary is provided to introduce a selection of concepts in a simplified form that are further described below in the detailed description. The summary is not intended to identify key features or essential features of the claimed subject matter, nor is it intended to be used to limit the scope of the claimed subject matter. Moreover, one or more of the steps and/or components described above may be optional or may be combined with other steps.

### BRIEF DESCRIPTION OF THE DRAWINGS

Systems and methods are illustrated by way of example and are not limited in the accompanying figures in which like reference numerals indicate similar elements and in which:

FIG. 1 shows an illustrative operating environment in which various aspects of the disclosure may be implemented.

FIG. 2 is an illustrative block diagram of computing device that may be used to implement the processes and functions of certain aspects of the disclosure.

FIG. 3 is an illustration of a one or more lines including a combination of selected numbers used to generate a ticket object in accordance with certain aspects of the disclosure.

FIG. 4 is an illustration of a graphical user interface including a user selected combination of numbers in accordance with certain aspects of the disclosure.

FIG. 5 is a flow diagram for ticket object processing in accordance with certain aspects of the disclosure.

FIG. 6 is a flow diagram for ticket object processing in accordance with certain aspects of the disclosure.

FIGS. 7A-C show examples of ticket processing in accordance with certain aspects of the disclosure.

FIGS. 8A and 8B illustrate examples of network configurations of various systems interacting in accordance with certain aspects of the disclosure.

### DETAILED DESCRIPTION

In light of the foregoing background, the following presents a simplified summary of the present disclosure in order to provide a basic understanding of some aspects of the concepts disclosed herein. This description is not an extensive overview of the invention. This description is not intended to identify key features or essential features of the claimed subject matter, nor is it intended to be used to limit the scope of the claimed subject matter. This description is provided to introduce a selection of concepts in a simplified form that are further described below. It is to be understood that other embodiments may be utilized and structural and functional modifications may be made.

A gaming platform may be used to operate a variety of games in which a user wins the game by selecting a combination of selected numbers that matches a winning combination of selected numbers. Operation of a game may include the use of tickets, obtained by a user, that include a combination of numbers selected by users. The game operated on the gaming platform may include a draw in which a random set of winning numbers is generated. If a user selected combination of selected numbers matches the set of winning numbers the user wins the game. If multiple users select the same combination of selected numbers then multiple users may win the game. However, if none of the user selected combinations of numbers match the winning numbers then another set of winning numbers will be drawn. Under such circumstances it is possible for the multiple ‘winning numbers’ to be generated without an actual winner (e.g., a user having selected the same combination of selected numbers). As such, the users will start anew when another winning number is generated and compared to a new set of user selected numbers. However, there is no guarantee that the user selected numbers will match any of the subsequent winning numbers. Further, the situation in which multiple users win is the result of multiple users being able to select the same combinations of numbers, which leads to lower user satisfaction due to the winner no longer being an exclusive winner. Further, the situation in which no user selected combination of numbers matches the winning number is more likely when users are able to select the same combination of numbers. The disclosed technology overcomes both of these situations by providing a user-friendly way for users to select combinations of numbers that have not been chosen by other users. Further, by tracking the numbers that have been selected, the disclosed technology may under certain circumstances (e.g., the number of user selected tickets is equal to the total number of possible combinations of numbers) ensure that a user selected combination of selected numbers wins the game, thereby improving user satisfaction. To achieve the benefits of a more effective gaming platform the disclosed technology may use novel queuing techniques to process objects including ticket objects associated with ticket events.

In accordance with various aspects of the disclosure, methods, computer-readable media, and apparatuses are disclosed involving the operation of a gaming platform in which non-redundant game tickets are provided to players. In some examples, the computing system comprises the ability to track previously selected combinations of numbers and generate unique combinations of numbers for players. As a result, users may enjoy enhanced performance and reduced latency when performing the technical task of processing and updating the status of a ticket array that is used to keep track of the state of different combinations of tickets.

In the following description of the various embodiments of the disclosure, reference is made to the accompanying drawings, which form a part hereof, and in which is shown by way of illustration, various embodiments in which the disclosure may be practiced. It is to be understood that other embodiments may be utilized and structural and functional modifications may be made.

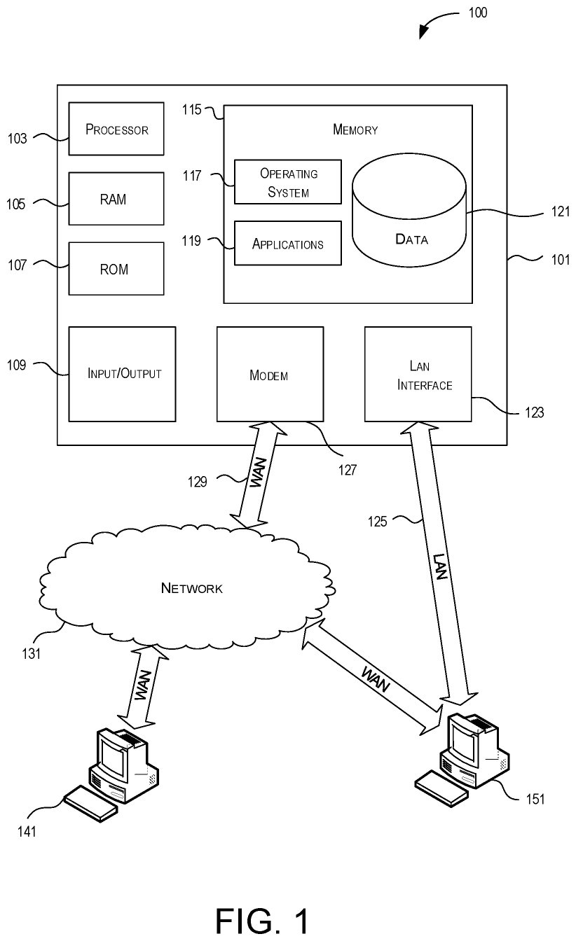

### FIG. 1

FIG. 1 shows an illustrative operating environment in which various aspects of the disclosure may be implemented. The system 100 includes a computing device 101 (e.g., a server computing system) that may be used according to an illustrative embodiment of the disclosure. The computing device 101 may have a processor 103 for controlling overall operation of the computing device 101 and its associated components, including RAM 105, ROM 107, input/output module 109, and memory 115.

I/O 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 115 to provide instructions to processor 103 for enabling computing device 101 to perform various functions. For example, memory 115 may store software used by the computing device 101, such as an operating system 117, application programs 119, and an associated database 121. Processor 103 and its associated components may allow the computing device 101 to run a series of computer-readable instructions to deploy program instructions according to the type of request that the computing device 101 receives. For instance, if a client computing device requests that program instructions for the generation of a ticket object should be executed, computing device 101 may transmit the appropriate instructions to a user's computer when that user visits the client's website.

The computing device 101 may operate in a networked environment supporting connections to one or more remote computers, such as terminals 141 and 151. The terminals 141 and 151 may be personal computers or servers that include many or all of the elements described above relative to the computing device 101. Alternatively, terminal 141 and/or 151 may be part of a “cloud” computing environment located with or remote from computing device 101 and accessed by computing device 101. The network connections depicted in FIG. 1 include a local area network (LAN) 125 and a wide area network (WAN) 129, but may also include other networks. When used in a LAN networking environment, the computing device 101 is connected to the LAN 125 through a network interface or adapter 123. When used in a WAN networking environment, the computing device 101 may include a modem 127 or other means for establishing communications over the WAN 129, such as the network 131 (e.g., the Internet). It will be appreciated that the network connections shown are illustrative and other means of establishing a communications link between the computers may be used. The existence of any of various well-known protocols such as TCP/IP, Ethernet, File Transfer Protocol (FTP), Hypertext Transfer Protocol (HTTP) and the like is presumed.

Additionally, an application program 119 used by the computing device 101 according to an illustrative embodiment of the disclosure may include computer executable instructions for invoking functionality related to delivering program instructions and/or content.

Computing device 101 and/or terminals 141 or 151 may also be mobile terminals including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, and distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

Referring to FIG. 1, an illustrative system for implementing methods according to the present disclosure is shown. As illustrated, system may include one or more workstations 141, 151. Workstations 141, 151 may be local or remote, and are connected by one or more communications links to computer network 101. In certain embodiments, workstations 141, 151 may be different storage/computing devices for storing and delivering client-specific program instructions or in other embodiments workstations may be user terminals that are used to access a client website and/or execute a client-specific application. Computer network 100 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links may be any communications links suitable for communicating between workstations and server, such as network links, dial-up links, wireless links, hard-wired links, etc.

The steps that follow in the Figures may be implemented by one or more of the components in FIG. 1 and/or other components, including other computing devices.

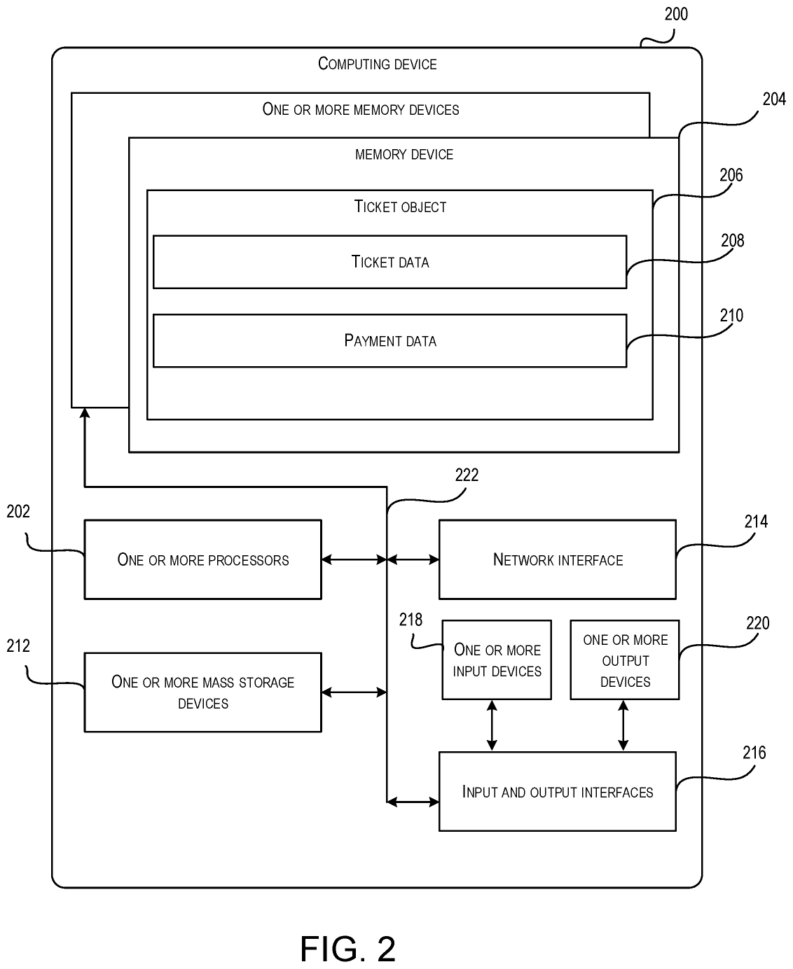

### FIG. 2

FIG. 2 is an illustrative block diagram of computing device that may be used to implement the processes and functions of certain aspects of the disclosure. Any of the computing devices and/or systems described herein may be implemented, using any of the one or more computing devices described with respect to FIG. 2. The computing device 200 may include any of the features and/or capabilities of the computing device 101 that is illustrated in FIG. 1.

The computing device 200 may include one or more processors 202, one or more memory devices 204, one or more mass storage devices 212, a network interface 214, input and output interfaces 216, one or more input devices 218, one or more output devices 220, and/or one or more interconnects 222. The one or more memory devices 204 may store the ticket object 206 The computing device 200 is not limited to the configuration illustrated in FIG. 2 and may include any number of processors, memory devices, mass storage devices, input and output interfaces, interconnects, and/or network interfaces. Further, any of the processors, memory devices, mass storage devices, input and output interfaces, interconnects, and/or network interfaces may be provided as any combination of separate components and/or as parts of the same component.

The one or more processors 202 may include one or more computer processors that are configured to execute one or more instructions stored in the one or more memory devices 204. The one or more processors 202 may include one or more general purpose central processing units, one or more application specific integrated circuits (ASICs), one or more graphics processing units (GPUs), and/or one or more field programmable arrays (FPGAs). Further, the one or more processors 202 may include single core devices and/or multiple core devices that may include one or more microprocessors, one or more microcontrollers, one or more integrated circuits, and/or one or more logic devices. In some embodiments, the one or more processors 202 may perform one or more operations to process the ticket object 206. For example, the one or more processors 202 may perform one or more operations comprising accessing the ticket object 206, processing the ticket object 206, and updating a ticket array with a combination of selected numbers from the ticket object. Further, the one or more processors 202 may perform operations to add the ticket object 206 to a ticket queue, determine whether the ticket object meets ticket criteria, process ticket data associated with the ticket object, and generate a notification.

The one or more memory devices 204 may store information and/or data (e.g., the ticket object 206). Further, the one or more memory devices 204 may include one or more non-transitory computer readable storage media, including RAM, ROM, EEPROM, flash memory devices, magnetic disks, and/or any of the memory devices described herein (e.g., the memory 112 illustrated in FIG. 1). The information and/or data stored by the one or more memory devices 204 may include instructions to perform one or more operations. Further, the instructions stored by the one or more memory devices 204 may be executed by the one or more processors 202. Execution of the instructions may cause the computing device 200 to perform one or more operations including the one or more operations described herein.

The one or more memory devices 204 and/or the one or more mass storage devices 212 are illustrated as separate entities in FIG. 2. However, the one or more memory devices 204 and/or the one or more mass storage devices 212 may occupy different portions of the same memory device. The one or more memory devices 204 and/or the one or more mass storage devices 212 may include one or more computer-readable media that may include but is not limited to non-transitory computer-readable media described above.

The one or more memory devices 204 may store instructions for one or more applications. The one or more applications may include an operating system that may be associated with various software applications and/or data. In some embodiments, the one or more memory devices 204 may store a general-purpose operating system that executes on the computing device 200. Further, the one or more memory devices 204 may store instructions that allow software applications to access data, including data associated with the ticket object 206.

The software applications that may be executed by the computing device 200 may include applications associated with the computing system 100 that is illustrated in FIG. 1. Further, the software applications operated by the computing device 200 may include applications that operate locally and/or applications that are executed remotely (e.g., web applications that are executed on a server computing system with inputs received by the computing device 200 which may operate as a client device).

The ticket object 206 may include one or more portions of data that are stored in one or more memory devices 204. Furthermore, the ticket object may include ticket data 208 which may include a combination of selected numbers that may be used processed as part of operating a game. Further, the ticket object 206 may include payment data 210, which may be used to pay for the game. For example, the payment data 210 may include account information for a payment account of a user and user authorization information indicating that a user has authorized funds to be withdrawn from the user's payment account.

The one or more interconnects 222 may include one or more interconnects or buses that may be used to send and/or receive one or more signals (e.g., electronic signals) and/or data (e.g., the ticket object 206) to and/or from one or more components of the computing device 200 (e.g., the one or more memory devices 204, the one or more processors 202, the one or more mass storage devices 212, the network interface 214, and/or the input and output interfaces 216). The one or more interconnects 222 may be configured and/or arranged in various ways including as parallel or serial connections. Further, the one or more interconnects 222 may include one or more internal buses to connect the internal components of the computing device 200; and/or one or more external buses to connect the internal components of the computing device 200 to one or more external devices. For example, the one or more interconnects 222 may include different interfaces including ISA, EISA, PCI, PCI Express, Serial ATA, Hyper Transport, and/or other interfaces that may be used to connect components of the computing device 200.

The one or more mass storage devices 212 may be used to store data including the ticket object 206. The one or more mass storage devices 212 may include one or more solid state drives (SSDs), one or more hard disk drives (HDDs), and/or one or more hybrid drives including HDDs and SSDs.

The network interface 214 may support network connections including connections to communicate via one or more networks. The one or more networks to which the computing device 200 is connected via the network interface 214 may include a local area network, a wide area network, and/or the Internet.

The input and output interfaces 216 may include one or more input interfaces to receive input from the one or more input devices 218 and/or the one or more output devices 220. The one or more input device 218 may be used to provide one or more inputs to the computing device 200. The one or more input devices 218 may include one or more keyboards, one or more mouse devices, one or more touch input devices (e.g., a capacitive touch screen and/or a resistive touch screen), one or more microphones, and/or one or more cameras. The one or more output devices 220 may include one or more visual output devices (e.g., display devices including LCD displays and/or OLED displays) and/or one or more audio output devices (e.g., one or more loudspeakers).

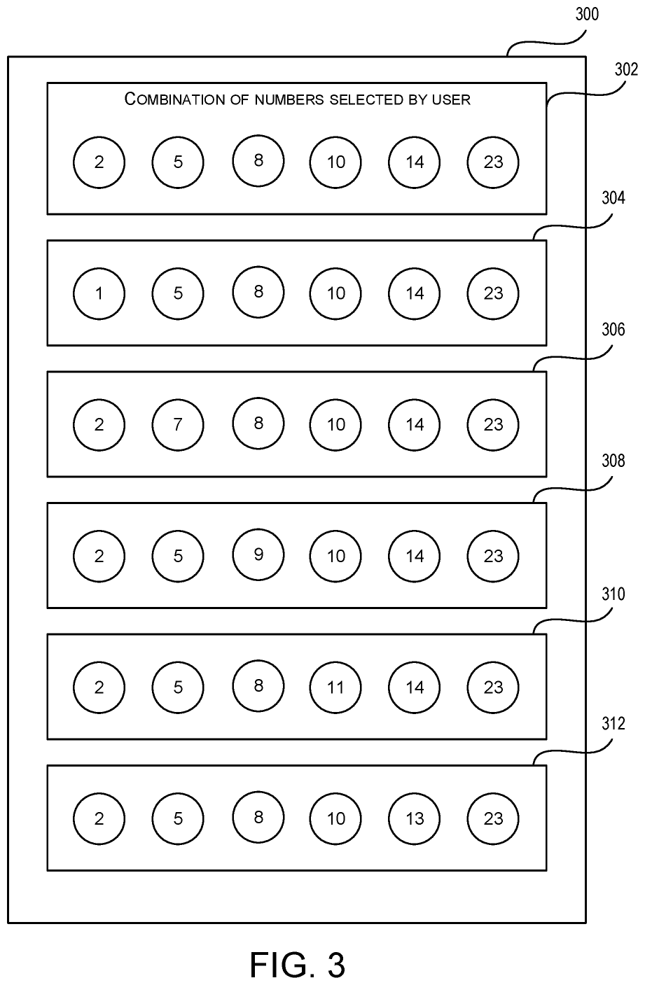

### FIG. 3

FIG. 3 is an illustration of a one or more lines including a combination of selected numbers used to generate a ticket object in accordance with certain aspects of the disclosure. The combination of selected numbers may be selected using a computing device (e.g., the computing device 200 that is illustrated in FIG. 2).

In this example, the combination of selected numbers 302 is based on user input (e.g., a user selecting the combination of selected numbers via a graphical user interface of a computing device). After the combination of selected numbers 302 is selected, the computing device may compare the combination of selected numbers 302 to ticket array that includes a plurality of lines including other combinations of numbers that have already been claimed/purchased for a game. The computing device may determine that the combination of selected numbers was selected by another user and will provide the user with the lines 304-312 which are based on the combination of selected numbers but do not match any of the lines in the ticket array. For example, the computing device may generate the lines 304-312, each of which only change one number in the combination of selected numbers 302 in order to produce a unique line. The computing device may iteratively substitute different random numbers to produce a unique line while also maximizing the number of user selected numbers that are in the unique line. As shown in FIG. 3, each of the lines 304-312 includes five (5) of the six (6) user selected number 302.

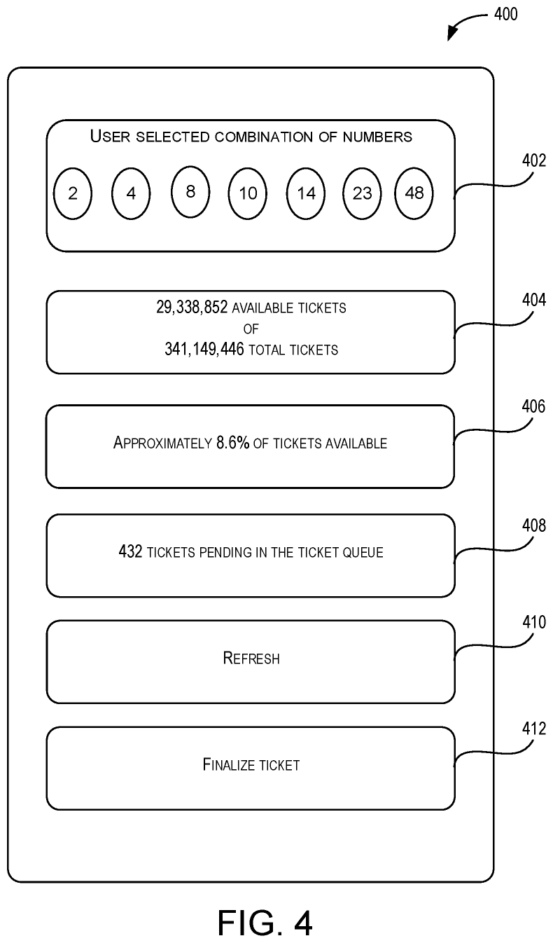

### FIG. 4

FIG. 4 is an illustration of a graphical user interface including a user selected combination of numbers in accordance with certain aspects of the disclosure. The combination of selected numbers may be selected using a computing device (e.g., the computing device 200 that is illustrated in FIG. 2).

The indication 402 includes the combination of selected numbers that are part of a ticket object generated by a user of the computing device 400. The indication 404 provides a number of available tickets (e.g., a number of the plurality of combinations of numbers that are marked as available in the ticket array) and a total number of tickets (e.g., a total number of the plurality of combinations of numbers in the ticket array including the plurality of combinations of processed numbers for the ticket event (e.g., a drawing of numbers for a particular event which may occur on a particular date and time) and the plurality of combinations of unprocessed numbers for the ticket event) that were initially available. The indication 406 indicates the percentage of available tickets (e.g., plurality of combinations of unprocessed numbers) which in this example, is approximately eight point six percent (8.6%) which represents the percentage of tickets that have not been processed. In some embodiments, the indication 406 may include an indication of the percentage of tickets that are no longer available (e.g., approximately ninety-one point four percent (91.4%) of tickets have been processed and are not available). The indication 408 provides a number of tickets that are currently pending in a ticket queue for the ticket event associated with the combination of selected numbers selected by the user. The control element 410 may be used to send a message to a server computing system that processes the ticket object. The message may include a request to refresh the indication 404 (e.g., provide a current number of available tickets) and/or the indication 408 (e.g., provide a current number of tickets pending in the ticket queue). The control element 412 may be used to confirm that the server computing system should complete processing of the ticket object.

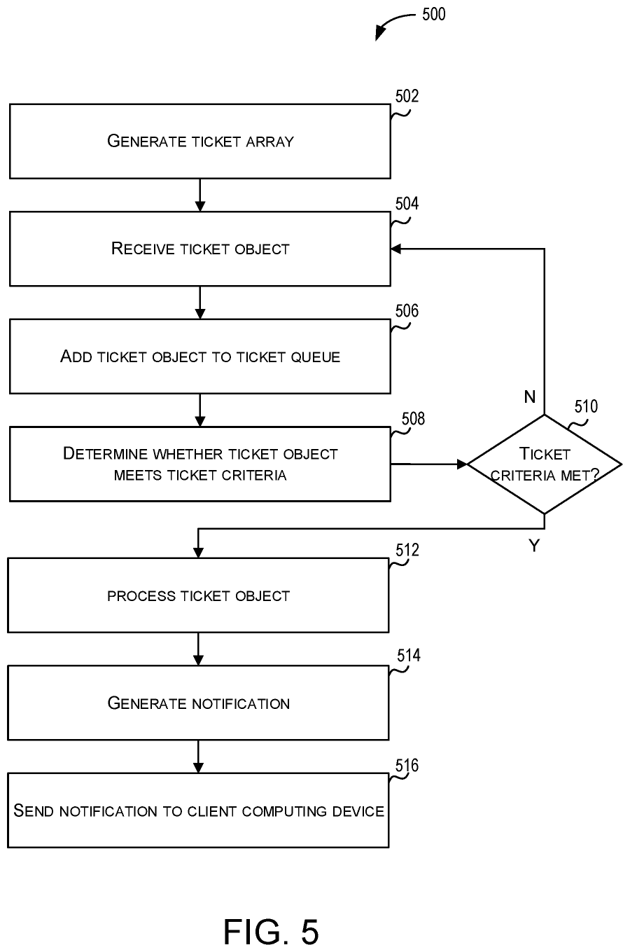

### FIG. 5

FIG. 5 is a flow diagram for ticket object processing in accordance with certain aspects of the disclosure. The method 500 may be performed by any suitable computing device and/or combination of computing devices, and are referred to herein as the system implementing the method 500.

At 502, the system may generate a ticket array. For example, a server computing device may generate a ticket array in which each element of the array corresponds to a combination of numbers. For example, a plurality of elements of the ticket array may correspond to a respective plurality of combinations of numbers. The ticket array may comprise a plurality of combinations of numbers consisting of a plurality of combinations of processed numbers for a ticket event (e.g., combinations of numbers that have been processed) and a plurality of combinations of unprocessed numbers for the ticket event (the same ticket event) that have not been processed. The plurality of combinations of numbers in the ticket array may be marked as processed or available (e.g., a combination of numbers that was selected by a user and processed in preparation for a particular ticket event) or marked as unprocessed or available (e.g., a combination of numbers that was not selected by a user, is available for selection by a user, and has not been processed by the system).

In some embodiments, the system may generate different types of data structures including a ticket stack, a ticked linked list, or a ticket tree. Any of the different data types generated by the system may be used in place of the ticket array that is described herein. For example, a ticket stack may be generated and comprise the plurality of combinations of processed numbers and/or the plurality of combinations of unprocessed numbers. In some embodiments, the ticket array may be based on parameters of the ticket event. For example, the ticket event may include parameters associated with the set of numbers that the plurality of combinations of numbers may be chosen from and/or the size of the set of numbers that may be selected for the ticket event. For example, a ticket event may include the parameters requiring that seven (7) mutually exclusive numbers from one (1) to fifty-nine (59) be selected from the ticket array.

At 504, the system may receive, obtain, retrieve, and/or access a ticket object. The ticket object may be received from one or more computing devices. For example, the ticket object may be received from a client computing device (e.g., a smartphone that performs operations to generate the ticket object). The ticket object may be associated with a ticket event. The ticket event may include a drawing of numbers that may be compared to a combination of selected numbers, selected by a user and associated with the ticket object, in order to determine whether the numbers that were drawn match the user selected combination of selected numbers. The ticket object may include various types of data and instructions that may be executed by a computing device (e.g., the computing device 101). For example, the ticket object may include ticket data that indicates one or more lines and/or one or more combinations of numbers associated with the ticket object.

For example, the ticket object may comprise a combination of selected numbers. Further, the combination of selected numbers may be mutually exclusive, such that no number in the combination of selected numbers is the same as any other number in the combination of selected numbers. In some examples, the combination of selected numbers may be non-mutually exclusive, such that any of the numbers in a set may be the same as any other number in the set. The ticket object may be associated with a gaming event in which a set of gaming numbers is drawn and compared to the combination of selected numbers associated with the ticket object.

In some embodiments, the ticket object may comprise one or more lines. A line may include some combination of selected numbers and at least one of the one or more lines may comprise the combination of selected numbers. For example, the one or more lines may correspond to a combination of one or more different combinations of numbers that were selected by a user and/or one or more different combinations of numbers that were randomly generated by the system.

In some embodiments, the ticket object may be based at least in part on a combination of user selected numbers and randomly selected numbers. For example, a ticket object in which a combination of seven (7) numbers may be selected, the user may select four numbers and the system may randomly generate the remaining three numbers. By way of further example, the user may request that the system randomly generate a combination of seven (7) preliminary numbers. In the event that the combination of preliminary numbers is acceptable to the user, the user may finalize the selection of the preliminary combination of numbers. In the event that the combination of preliminary numbers is not acceptable to the user, the system may generate a different combination of numbers. This process may be repeated until an acceptable combination of numbers that has not already been selected is generated for the user.

In another embodiment, the system may randomly generate a combination of preliminary numbers. The user may then add and/or remove one or more numbers in the combination of preliminary numbers that were randomly generated. For example, if the system generated the combination of numbers {1, 12, 14, 20, 22, 38} the user may choose to replace the number 12 with the number 13 to create a new combination of numbers {1, 13, 14, 20, 22, 38}. After the user selects a different number, the system may access the ticket array to determine whether the new combination of numbers was already selected. If the new combination of numbers was not already selected, the system may add the new combination of numbers to the ticket array. If the new combination of numbers was previously selected, the system may generate an indication for the user requesting that the user select a different number. Upon receiving a user input in response to the indication requesting the selection of a different number, the system may then check the ticket array to determine if the new combination of numbers with the different number was previously selected.

At 506, the system may add the ticket object to one or more ticket queues (e.g., the system may add the ticket object to a ticket queue). In some embodiments, the ticket queue may include one or more sub-queues that may be configured to process different operations associated with the ticket object. The ticket queue may be configured to hold the ticket object before the ticket object is processed. Further, the ticket queue may be configured to hold a plurality of ticket objects that comprise a plurality of combinations of selected numbers respectively. For example, the plurality of ticket objects may be ticket objects that are associated with other users or ticket objects that were previously sent by the same user. In some embodiments, the one or more ticket queues may include a primary queue and one or more secondary queues. The primary ticket queue (e.g., a locked ticket queue that a ticket object is initially added to) may contain time locked ticket objects associated with combinations of numbers that are locked (e.g., other users may not select the same combination of numbers in the time-locked ticket object) for a predetermined period of time (e.g., the primary ticket queue is locked for 1 hour or a day starting from the time the ticket object was added to the ticket queue). The secondary ticket queue may include released ticket objects that were previously in the primary ticket queue. The combinations of numbers associated with the ticket objects in the secondary ticket queue may remain marked as unprocessed in the ticket array.

In some embodiments, adding the ticket object to a ticket queue, which may be configured to hold the ticket object before the ticket object is processed, may comprise generating a timestamp for the ticket object. For example, a timestamp indicating the time, precise to the millisecond, may be generated and associated with the ticket object. Further, the system may arrange the ticket object in the ticket queue based on the time stamp such that the ticket object is placed ahead of any other ticket objects that are associated with the ticket event and have a more recent timestamp. For example, other ticket objects that have more recent timestamps will have lower priority, be placed further behind in the ticket queue, and will be processed after the ticket object associated with an older timestamp. Further, the ticket object may be placed behind any other ticket objects that are associated with the ticket event and have an older timestamp. For example, other ticket objects that have older timestamps will have higher priority, be placed further ahead in the ticket queue, and will be processed before the ticket object associated with more recent timestamp.

At 508, the system may determine whether the ticket object meets ticket criteria (e.g., one or more ticket criteria). The ticket criteria may comprise a ticket criterion associated with a uniqueness of the combination of selected numbers for the process of elimination for the ticket event. The ticket criteria may comprise criteria that are used to determine whether the combination of selected numbers in the ticket object match one or more combinations of numbers that are associated with the same ticket event. For example, meeting the ticket criteria may include determining that the combination of selected numbers associated with the ticket object do not match another combination of selected numbers that were processed for the same ticket event.

At 510, in response to the ticket object meeting at least one of the ticket criteria, the system may at 512 process the ticket object. In response to the ticket object not meeting at least one of the ticket criteria, the system may receive a ticket object (e.g., a new ticket object or another ticket object) at 504.

Processing the ticket object may include determining whether one or more queue locking criteria have been met. The one or more queue locking criteria may comprise a threshold number of ticket objects (e.g., a threshold number of ticket objects that may be in the ticket queue at the same time). Further, the one or more queue locking criteria may comprise a ticket event deadline occurring (e.g., a drawing date and time for the ticket event) and/or a rate of adding ticket objects to the ticket queue exceeds a rate threshold.

In response to determining that at least one of the one or more queue locking criteria have been met, the system may lock the ticket queue. Locking the ticket queue prevents any ticket object from being added to the ticket queue until one or more queue unlocking conditions have been met. For example, the system may lock the ticket queue when the ticket queue is determined to be at full capacity, in which case, attempting to add additional ticket objects to the ticket queue may result in the occurrence of errors.

When the ticket queue is locked the system may generate a notification to the user indicating that there will be a delay before the ticket is processed. For example, the server computing device may send the notification of the delay to a client computing device (e.g., a smartphone running software to generate ticket objects).

Processing the ticket object may include updating ticket array with the combination of selected numbers. The ticket array may comprise a plurality of combinations of processed numbers that are associated with the ticket event. Further, updating the ticket array may include storing the combination of selected numbers in the ticket array. In some embodiments, updating the ticket array may include adding the combination of selected numbers to the ticket array. By way of example, the server computing system may access the ticket array and change the combination of unprocessed numbers corresponding to the combination of selected numbers to indicate that the particular combination is now a combination of processed numbers. In some embodiments, the ticket array may include a plurality of flags that are used to indicate whether a combination of numbers is processed or unprocessed. Further, updating the ticket array may include changing the state of the flag from an unprocessed state to a processed state.

In some embodiments, updating the ticket array with the combination of selected numbers may comprise determining whether the combination of selected numbers matches any of the plurality of combinations of processed numbers. For example, the system may compare the combination of selected numbers to each of the plurality of combinations of processed numbers to determine whether there is a plurality of combinations of processed numbers that matches the combination of selected numbers. Further, in response to the combination of selected numbers not matching any of the plurality of combinations of processed numbers, the combination of selected numbers may be added to the ticket array. For example, the combination of selected numbers that do not match the plurality of combinations of processed numbers means that the combination of selected numbers were not previously part of the ticket array and the combination of selected numbers may then be added to the other numbers in the plurality of combinations of processed numbers that are part of the ticket array.

Further, the system may update the ticket object to indicate that the ticket object may be removed from the ticket queue. For example, the ticket object may have a removal flag that is updated (after the combination of selected numbers have been stored in the ticket array) to a removal state indicate that the ticket object may be removed from the ticket queue. The system may detect that the removal flag is in the removal state and determine that the ticket object may be removed from the ticket queue.

Further, in response to the combination of selected numbers matching any of the plurality of combinations of processed numbers, the system may generate a new combination of selected numbers that does not match any of the plurality of combinations of processed numbers. For example, if the plurality of combinations of processed numbers includes the plurality of combinations of processed numbers {4, 7, 12, 27, 28, 32} which matches the combination of selected numbers {4, 7, 12, 27, 28, 32} the system may generate the new combination of selected numbers {5, 8, 13, 29, 30, 33} that does not match any of the plurality of combinations of processed numbers which does not include the numbers {5, 8, 13, 29, 30, 33}.

The new combination of selected numbers may comprise at least one randomly generated number. For example, the system may use a random number generator to generate a new combination of selected numbers that includes a combination of at least one randomly generated number and some of the numbers of the combination of selected numbers.

Processing the ticket object may include the system determining whether one or more queue unlocking conditions have been met. For example, the system may monitor the ticket queue to determine whether the rate of adding ticket objects to the ticket queue is below a rate threshold (e.g., a fixed threshold or a variable threshold that may change depending on the time or date). The one or more queue unlocking conditions may comprise a predetermined amount of time elapsing, a number of ticket objects in the ticket queue being below a ticket threshold, and/or a rate of adding ticket objects to the ticket queue being below a rate threshold. The queue unlocking condition of a predetermined amount of time elapsing may include the use of a timer that may be associated with a ticket object when the ticket object is added to the ticket queue. The timer may be set to a default amount of time or may be a variable duration timer that is dependent on factors including the number of other ticket objects that are currently in the ticket queue and/or a number of lines and/or combinations of numbers that are associated with a ticket object. For example, the amount of time associated with the ticket object may be positively correlated with the number of lines and/or the combinations of numbers associated with the ticket object.

The queue unlocking condition of a number of ticket objects in the ticket queue being below a ticket threshold may include a determination of the number of ticket objects that are currently in the ticket queue. Further, the ticket queue may be unlocked when the number of ticket objects that are currently in the queue is less than a ticket object threshold.

The queue unlocking condition of rate of adding ticket objects to the ticket queue being below a rate threshold may be based at least in part on tracking, by the system, of the rate at which ticket objects are added to the ticket queue. For example, the ticket queue may be unlocked when the rate of ticket objects being added to the queue is less than a rate of ticket objects being removed from the queue. In some embodiments, the system may lock the ticket queue when the rate of adding tickets to the queue exceeds a threshold processing rate. For example, the threshold processing rate may be a maximum rate at which the system may process ticket objects in the ticket queue. As a result, when the rate of adding ticket objects to the queue is equal to or a predetermined amount below the threshold processing rate, the system may lock the ticket queue until the rate of adding tickets to the queue is lower.

In response to at least one of the one or more queue unlocking conditions being met, the system may unlock the ticket queue after updating the ticket object. For example, after the system determines that the one or more queue unlocking conditions have been met, the system may change a ticket queue state flag from the locked state to the unlocked state. When the ticket queue is unlocked, other ticket objects may be added to the ticket queue.

In some embodiments, processing the ticket object may comprise removing the ticket object from the ticket queue after the ticket object has been processed. For example, when processing of the ticket object has been completed and the one or more queue unlocking conditions have been met, the ticket object may be removed from the ticket queue. By way of further example, processing the ticket object may comprise removing the ticket object when one or more of the ticket criteria (e.g., at least one of the ticket criteria or some portion of the ticket criteria) have not been met for greater than a predetermined amount of time. For example, when the ticket criteria have been met for greater than one hour, the ticket object may be removed from the ticket queue.

At 514, the system may generate a notification. The notification may be generated after the ticket object has been processed. For example, the system may generate the notification “THE TICKET HAS BEEN PROCESSED” that may later be sent to a client computing device operated by the user that selected the combination of selected numbers associated with the ticket object. In some embodiments, the notification may include any combination of sounds (e.g., a notification chime), haptics (e.g., a vibration of the client computing device), images (e.g., a notification indicator that may include a picture/icon that is generated on a graphical user interface of the client computing device), and/or text (e.g., text indicating that the ticket object has been processed which may be provided as a text message to a mobile device, an e-mail message, and/or text in an interface of a computing application used to generate the ticket object).

At 516, the system may send the notification to the client computing device. For example, a server computing system may send a notification that the combination of selected numbers that were selected by a user of the client computing device have been processed for the ticket event. In some embodiments, the client computing device may be a mobile computing device (e.g., a smartphone), and the one or more user inputs may be received via a graphical user interface of the client computing device (e.g., a software application that runs on the operating system of the smartphone and which includes a graphical user interface that is used to select the combination of selected numbers)

In some embodiments, determining whether the ticket object meets one or more of the ticket criteria associated with a uniqueness of the combination of selected numbers may include determining that one or more of the ticket criteria are not met when a number of the plurality of combinations of processed numbers in the ticket array exceeds a sum total of different combination of the combination of selected numbers. For example, the sum total of different combinations of a set of seven (7) unordered and non-repeating numbers from one (1) to fifty-nine (59) may be chosen may be determined based on the binomial coefficient and would be equal to three-hundred and forty-one million one hundred and forty-nine thousand four hundred and forty six (341,149,446) different combinations. The system may determine that the ticket array will include a total of 341,149,446 combinations of numbers such that no more than 341,149,446 unique numbers may be selected.

Processing the ticket object may include determining whether the combination of selected numbers matches at least one of the plurality of combinations of processed numbers. For example, the system may compare the combination of selected numbers to the plurality of combinations of processed numbers to determine whether the combination of selected numbers matches at least one of the plurality of combinations of processed numbers. In response to the combination of selected numbers matching at least one of the plurality of combinations of processed numbers, the system may determine the plurality of combinations of processed numbers that have the lowest Jaccard distance relative to the combination of selected numbers. For example, the system may generate one or more intersections over union for the combination of selected numbers relative to each of the plurality of combinations of processed numbers. The system may then determine respective Jaccard distances for each of the one or more intersections over union.

The system may then replace one or more numbers of the combination of selected numbers until the combination of selected numbers does not match any of the plurality of combinations of processed numbers. For example, if the combination of selected numbers includes seven numbers, the system may access the ticket array and replace the numbers of the combination of selected numbers one at a time until the new combination of selected numbers does not match any of the plurality of combinations of processed numbers. If all combinations of the first number have been replaced, the system may replace the second number in the same manner and replace each number in the set. If all combinations of replacing one number do not result in a unique new combination of selected numbers, the system will replace additional numbers (e.g., two numbers or three numbers) until a unique new combination of selected numbers has been generated.

In some embodiments, the ticket array may comprise a plurality of processed hash values corresponding to a plurality of combinations of processed numbers that were hashed using a hash function. For example, one or more previously selected combinations of numbers may have been entered into the hash function to produce output respectively comprising one or more previously processed hash values. Further, determining whether the ticket object meets one or more of the ticket criteria associated with a uniqueness of the combination of selected numbers may include generating, based at least in part on the combination of selected numbers and the hash function, a hashed ticket value. For example, the combination of selected numbers may be provided as an input to the same hash function that was used to generate the one or more previously processed hash values. The hash function would then generate the hashed ticket value based on the combination of selected numbers that was used as an input. The system may then compare the hashed ticket value to the plurality of processed hash values to determine whether there is a match between the hashed ticket value and at least one of the plurality of processed hash values.

In response to the hashed ticket value matching any of the plurality of processed hash values, a notification that the combination of selected numbers is not unique may be generated. For example, if the hashed ticket value matches any of the plurality of processed hash values, the system may generate a notification indicating “THE CURRENTLY SELECTED COMBINATION OF SELECTED NUMBERS HAS ALREADY BEEN PLAYED. PLEASE SELECT ANOTHER COMBINATION OF SELECTED NUMBERS.”

In some embodiments, the system may send the notification to one or more computing devices. For example, the server computing system may send the notification that the ticket object has been processed to a client computing device that sent the ticket object to the server computing device. The notification may include any of the information associated with the ticket object including the combination of selected numbers and an indication of which, if any, of the combination of selected numbers were generated by the server computing system (e.g., randomly generated numbers).

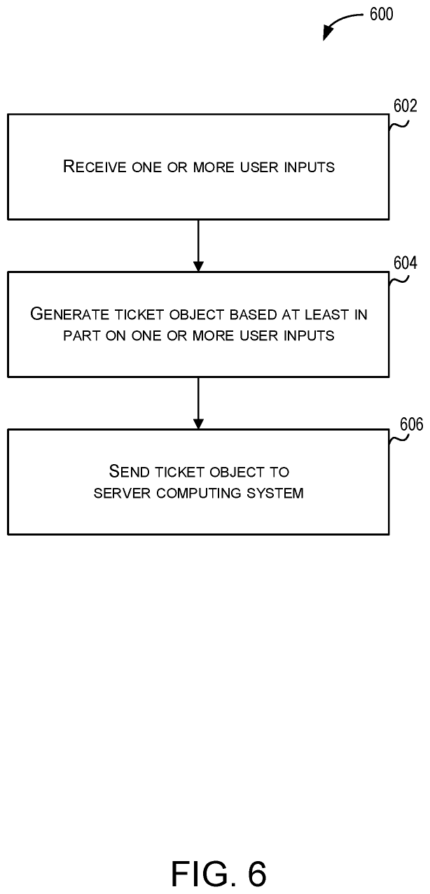

### FIG. 6

FIG. 6 illustrates a flowchart illustrating an example method 600 to process ticket objects. The method 600 may be performed by any suitable computing device and/or combination of computing devices, and are referred to herein as the system implementing the method 600.

At 602, the system may receive, obtain, retrieve, and/or access one or more user inputs comprising information associated with the ticket object. For example, the one or more user inputs may include the combination of selected numbers selected by a user.

In some embodiments, the one or more user inputs may correspond to the combination of selected numbers. Further, generating the ticket object may be based at least in part on the one or more user inputs. For example, if the one or more user inputs include entry by the user of the numbers “5,” “8,” “14,” “20,” “48,” and “49” and the combination of selected numbers corresponding to the one or more user inputs may include {5, 8, 14, 20, 48, 49}.

In some embodiments, the one or more user inputs may correspond to payment data comprising a payment account and authorization to access a user determined amount from the payment account. For example, if the one or more user inputs include entry by the user of a payment account number and selection of a user control that authorizes a user determined amount to be withdrawn from the payment account in order to pay for the combination of selected numbers associated with the ticket object. Generation of the payment data may be required in order to meet one or more of the ticket criteria.

At 604, the system may generate the ticket object based at least in part on the one or more user inputs. For example, the one or more user inputs may include an input to a control element of a user interface (e.g., a graphical user interface) that activates the generation of a ticket object that includes the combination of selected numbers selected by the user.

At 606, the system may send the ticket object to a computing system (e.g., a server computing system). For example, the system may send the ticket object via a communications network (e.g., the network 131 depicted in FIG. 1) through which the system and the server computing system may communicate. In some embodiments, the client computing device may use a synchronous communication protocol to send the ticket object to the server computing system.

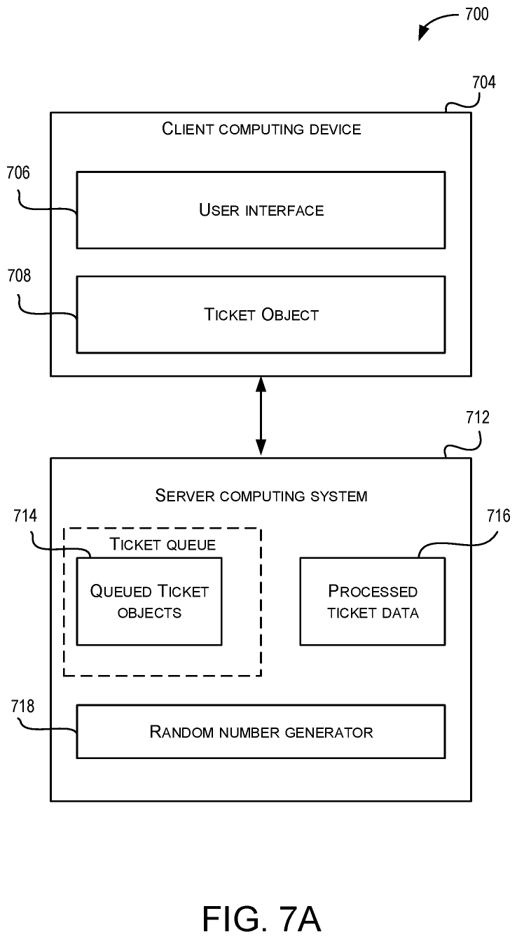

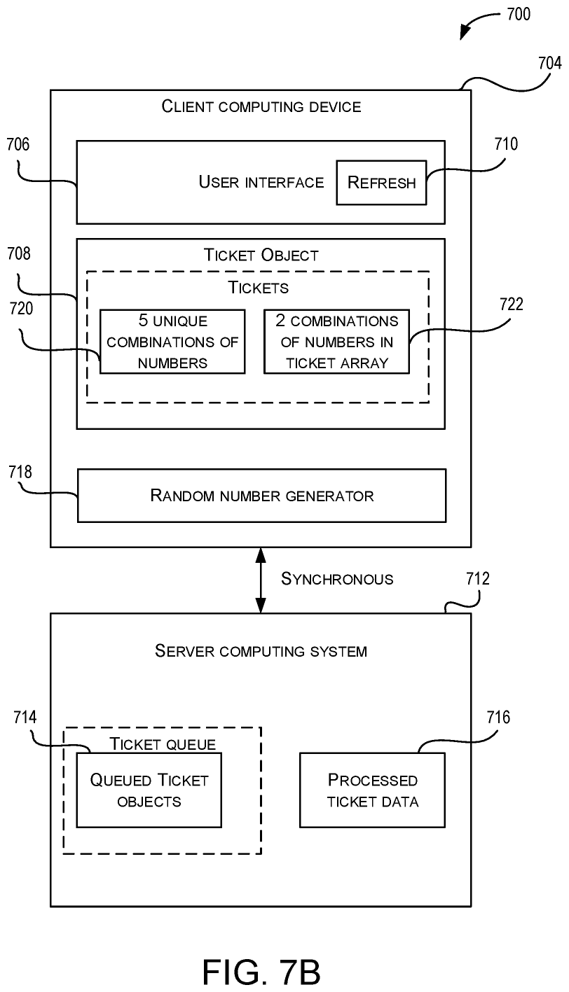

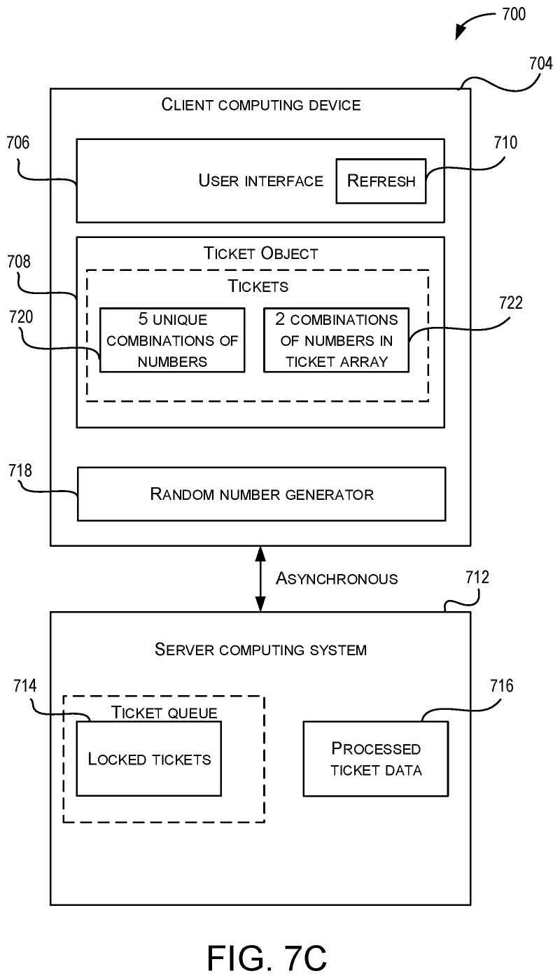

FIGS. 7A-C show examples of ticket processing in accordance with certain aspects of the disclosure.

FIG. 7A

FIG. 7A depicts a block diagram of a synchronous interaction between a client computing device and a server computing system. As illustrated in FIG. 7, a user has generated a ticket object 708 after accessing a web page associated with generating the ticket object 708. For example, the user may access the web page that includes a user interface 706 (e.g., a graphical user interface) of a web browser that is implemented on the client computing device 704. The user interface 706 allows the user to select and/or enter a combination of selected numbers that will be stored in the ticket object 708. In some embodiments, the user may select a one or more lines (e.g., each line comprising a combination of selected numbers) by providing one or more inputs to the user interface 706 of the webpage. By way of example, the user may select the line 302 shown in FIG. 3 which includes the combination of selected numbers {2, 5, 8, 10, 14, 23}. Further, based on the selection of the combination of selected numbers 302, the computing device (e.g., a smartphone) may generate the one or more lines 304-312 shown in FIG. 3 based on the combination of selected numbers 302. In some embodiments, the combination of selected numbers may be generated based on the user selecting a random number option in which a computing device 704 generates the combination of selected numbers using a random number generator 718. In some embodiments, the random number generator 718 may generate a random number based at least in part on a current time (e.g., a current time to the millisecond may be used to generate a random seed that is provided as an input to the random number generator 718). A cookie on the browser of the computing device (e.g., the computing device 704) may store the user's currently selected array of numbers. In one example a cookie may store an array of numbers for an online game in which a randomly generated line is provided and compared to user selected lines to determine a winner. A scripting language (e.g., Javascript) may be used to make a server call to a random number function that generates a set of random numbers in accordance with the rules of a particular game. For example, a random number generator 718 may generate a predetermined or selected number of lines (e.g., five (5) lines), with each line consisting of a combination of selected numbers (e.g., six (6) numbers) in which each number is within a predetermined range (e.g. one (1) through fifty-two (52)).

In some embodiments, the selection of the one or more lines may be based at least in part on a set of preliminary numbers that contains a greater amount of numbers than the combination of selected numbers that is used in the one or more lines. For example, the user may select ten (10) preliminary numbers, and the computing device may select one or more lines of six (6) numbers in total with each line comprising a unique sets of six (6) numbers selected from the set of ten (10) preliminary numbers. By way of further example, if the line can include numbers in a range from one to fifty (1-50) and the user selects ten (10) preliminary numbers (e.g., the preliminary numbers 2, 8, 12, 18, 22, 28, 32, 38, 42, 48) the computing device may generate the lines 2, 8, 12, 18, 22, and 28; 2, 12, 18, 22, 28, and 32; and/or 18, 28, 32, 38, 42, and 48. As indicated in the preceding example, the computing device may generate lines that include unique combinations of six (6) numbers selected from the ten (10) preliminary numbers that the user selected.

The client computing device 704 may generate a ticket object 708 that includes the one or more lines. The ticket object (sometimes referred to as “current_ticket_object”) may be a HTML/CSS representation of the ticket the user is about to purchase. The ticket object may be modified as the user makes changes via the graphical user interface. The ticket object is also attached to the final order and its current usage is mainly for the receipt; where the receipt (e.g., an email receipt) shows a graphic representation of the exact ticket that the user purchased. In some examples, the ticket object may also include a unique identifier that may be used to associate the combination of selected numbers with a particular transaction and/or a particular user. In some embodiments, the ticket object may be stored on the client computing device. For example, the ticket object may be stored for later use by the user, thereby obviating the need to re-enter the numbers.

The computing device 704 may then send data comprising the ticket object to a server computing system 712. The server computing system 712 may be associated with an entity (e.g., a gaming platform authority) that is authorized to distribute, track, and/or process ticket objects for the purpose of operating a game in which a predetermined number of tickets are generated for users and a winning user is determined when a predetermined number of the user selected tickets have been generated and the combination of selected numbers associated with a user selected ticket matches the winning combination of selected numbers generated by the gaming platform. For example, the predetermined number may be determined based on the number of possible combinations of numbers for the game. Further, the server computing system 712 may randomly select a winning combination of selected numbers when all combinations of the combinations of numbers have been generated for users. As such, a user selected number will match the winning number whenever the game is played and the predetermined number of number of the user selected tickets have been generated. In some embodiments, a scripting language may be used to generate code that instructs the client computing device to send data comprising the ticket object 708 to the server computing system 712 shown in FIG. 7A. In one example, the request to the server computing system 712 may be via a web service call with various name-value pair parameters in the URL of the request. The script and its parameters may be used to keep the central database/data store synchronized with the numbers currently being given to the user on the gameplay/checkout steps.

When the server computing system 712 receives the ticket object, the ticket object may be placed in a ticket queue 714 that may include other ticket objects (e.g., ticket objects associated with other users and/or other ticket objects generated by the same user). In some embodiments, the position of the ticket object within the queue may be based on a first in first out (FIFO) method of processing. The ticket queue 714 may be configured to hold ticket objects for a predetermined amount of time. For example, the queue may be configured to hold ticket objects for no more than thirty seconds (or other amount of time more or less than 30 seconds). When the predetermined amount of time has elapsed, the ticket object may be sent back to the client computing device 704. In some embodiments, when a ticket object is returned without being purchased, the client computing device may be configured to generate a notification that the server computing system is busy add/or resend the ticket object to the server computing system. The processed ticket data 716 may include the ticket objects that have been processed and are included in the ticket array that includes the combinations of numbers that have been processed.

The combination of selected numbers associated with a ticket object may be compared to a plurality of combinations of processed numbers. Based on the comparison of the combination of selected numbers in the ticket object to the plurality of combinations of processed numbers, the server computing system may determine which of the combination of selected numbers in the ticket object have been purchased. In the event that some portion of the combination of selected numbers in the ticket object have been previously purchased, the ticket object may be modified such that any combination of selected numbers that has been picked is flagged.

In some embodiments, the combination of selected numbers that have not been selected may be purchased without further input from the user (e.g., the user may have pre-authorized the purchase of numbers that have not been previously selected). The server computing system would then send the transaction associated with the ticket object to a payment processor, add the one or more lines in the ticket object to the plurality of combinations of processed numbers, modify the ticket object to indicate that the ticket has been purchased, and send the ticket object to the computing device.

In some embodiments, the plurality of combinations of processed numbers may be cleared whenever a prize has been claimed and a new prize has been established. The plurality of combinations of processed numbers may then be repopulated when tickets for a new draw are purchased.

When the ticket object is received by the server computing system, the server computing system may, before the lines associated with the ticket are purchased, treat the lines in the ticket object as if the lines were part of the plurality of combinations of processed numbers. As such, the plurality of combinations of processed numbers may include temporary entries corresponding to the lines indicated in the ticket objects in the queue. The temporary entries may be made permanent when the corresponding ticket is purchased or removed from the plurality of combinations of processed numbers when a predetermined queue has elapsed.

The function call that executed the instructions that sent the ticket object to the server computing system may be synchronous such that the client side instructions (e.g., prompting the user to confirm their purchase of the ticket) may not be executed until the server computing system responds to the client computing device.

In this example, the This database comparison is done by server-side code running on the server computing system hitting the central database 814. In some embodiments, the client computing device may maintain a cached copy of previous ticket objects that include lines that the user previously selected. The cached copy may include lines associated with tickets the user previously purchased and/or lines that were sent to the server computing system and not purchased. For example, the cached copy may be stored in a cookie and/or a local JSON object)

The server-side code determines that two lines of the seven lines were previously purchased and marked as “purchased” in the central database table structure. The other lines are missing from the plurality of combinations of processed numbers, so the server-side code takes that to mean that those combos are still available. The server-side code returns the result of the Javascript function call to the browser, which then only allows the five still-available lines of combos to be displayed to the user in FIG. 2. The other two lines of combos are filtered out.

In some embodiments, the user may be provided with a predetermined amount of time to purchase the ticket. is given X number of seconds to purchase the five lines of combos. The Javascript code on the client-side runs a timer for those X seconds.

Assuming The user clicks “yes” to make the purchase, the client-side Javascript populates a cookie/JSON with the five lines of combos and some other information and sends the JSON in an asynchronous Javascript call to the server-side code for processing.

The server-side code may be used to instruct the server computing system to submit the five lines to a purchase engine on the server to officially “commit” the purchase to the central database 814 and make it final. The purchase engine may communicate with a purchase processing system that processes payment of the five lines.

In some embodiments, server-side code may instruct the server computing system to throw an exception when the same user attempts to repurchase a line that is in the plurality of combinations of processed numbers and was previously purchased by the same user for the same ticket event draw. Because the Javascript call was asynchronous, the server-side code sends something to the web browser to indicate the error in completing the purchase.

### FIG. 7B

Referring to FIG. 7B, similar to the example set forth in FIG. 7A, a user may select lines for a ticket via web browser by visiting a webpage or online site, and the system may perform similarly to the way set forth in FIG. 7A. A user interface 706 may be used by a user to select combinations of numbers and the control 710 may be used by a user to refresh the state of the user interface to indicate to the user the number of tickets the user may obtain. Based on a user's selection of numbers, the combination of numbers 720 has been determined to include five (5) unique combinations of numbers (lines) that are not in the ticket array. The combination of numbers 722 was determined to include two (2) non-unique combinations of numbers that are in the ticket array and may not be used by the user for a ticket event. However, when the server-side code determines that two lines of the seven lines were previously purchased and marked as “purchased” in the plurality of combinations of processed numbers, the server-side code may also be used to determine that those two lines are marked as “pending” in the central database table structure. The “pending” may indicate that the user currently has the two lines in her check-out cart awaiting the Javascript timer to expire.

### FIG. 7C

Referring to FIG. 7C, similar to the example set forth in FIG. 7A, a user may select lines for a ticket via web browser by visiting a webpage or online site, and the system may perform in a similar way as set forth in FIG. 7A.

Upon the user activating the “refresh” control 710 on the user interface 706 of the webpage or online platform, client-side script (e.g., Javascript) may execute a random number generator 718 (e.g., a client-side random number generator engine) to generate a new matrix of randomly generated lines (e.g., five lines or more or less) of combos. Then, these five lines may be sent via an asynchronous Javascript (AJAX) call to the server computing system to compare each of the lines of the new matrix to the lines of the plurality of combinations of processed numbers stored in the server computing system. An example, of instructions used by the system to generate a combination of selected numbers is illustrated below:

```
* Generate combination of selected numbers
  *
  * Combinations Formula: nCr = n!/(n-r)!
  * Where n is the number of things to choose from, and you choose r of
  them
  * @example You have 59 entries and you want to choose 7 of them,
that's 59P7 = 59!/7!(59-7)! = 341,149,446
  */
function getCombinations($base, $n) {
    $baselen = count($base);
  if ($baselen == 0) {
    return;
  }
  if ($n == 1) {
    $return = array( );
    foreach ($base as $b) {
      $return[ ] = array($b);
    }
    return $return;
  } else {
    $oneLevelLower = getCombinations($base, $n - 1);
    $newCombs = array( );
    foreach ($oneLevelLower as $oll) {
      $lastEl = $oll[$n - 2];
      $found = false;
      foreach ($base as $key => $b) {
        if ($b == $lastEl) {
          $found = true;
          continue;
        }
        if ($found == true) {
          if ($key < $baselen) {
            $tmp = $oll;
            $newCombination = array_slice($tmp, 0);
            $newCombination[ ] = $b;
            $newCombs[ ] = array_slice($newCombination, 0);
          }
        }
      }
    }
  }
  return $newCombs;
}
```

Because the call is AJAX (e.g., asynchronous script), the user's web browser may show the lines of combos in a ticket as in FIG. 3, but may be (optionally) noted as merely a tentative ticket.

Because the call is AJAX, the client-side browser does not wait for the server computing system to return the request. Rather, when the server computing system sends a return command/data/other communication to the client-side Javascript in the browser, the Javascript would trigger the user interface to modify the displayed tentative ticket to strike out (e.g., by greying out or otherwise visually modifying) those lines that are not actually available (e.g., because another user has already purchased it, another user is in the process of completing a purchase of it, and/or it was otherwise blocked from purchase e.g., by an administrator). Before the display is modified, the client-side code may confirm that the lines being displayed have not changed (e.g., that the user has not hit the “refresh” button again, or other action that results in the tentative ticket becoming obsolete has not occurred).

Finally, once the aforementioned has been validated/confirmed, a “complete transaction” button/control on the user interface may become active (e.g., enabled or un-greyed out or clickable) so that may actually proceed to complete the purchase of the remaining (i.e., un-struck) lines in the ticket. If the five lines on the currently displayed ticket on the user's screen have not changed and are returned by the server computing system to be OK, then when the user proceeds to complete the purchase of the ticket, the system may still operate as described in FIG. 7A.

In some embodiments, a two-queue mechanism may be used to implement the aforementioned example of FIG. 7C. In one hypothetical example, suppose there's a raffle with duplicate numbers and a very large queue of users (e.g., users of the electronic platform) sending ticket objects. However, only one person can win for each drawing's combination of numbers that is called. So a person who picked their numbers earlier would have first rights to the initial time when that combination is called. In other words, two queues may happen at the same time.

Therefore, a double queue system (or two-queue mechanism) may return a result for the current user's checkout, then the system compares that to the orders database for the current drawing. A ticket object (e.g., current_ticket_object) may be created as a HTML/CSS representation of the ticket that a user is about to purchase. And this ticket object may be modified as the user makes changes or as the backend server computer determines that a particular combination of numbers in the user's ticket object are already assigned to another user. In the infrequent event that another user has that set in their cart, the system may simply not accept that item in the order. Basically, the user's cart items may be reduced exactly at the time of checkout via a client-side script such as e.g., Javascript. And, a notification may be generated on the computer display notifying the user that their cart items were modified.

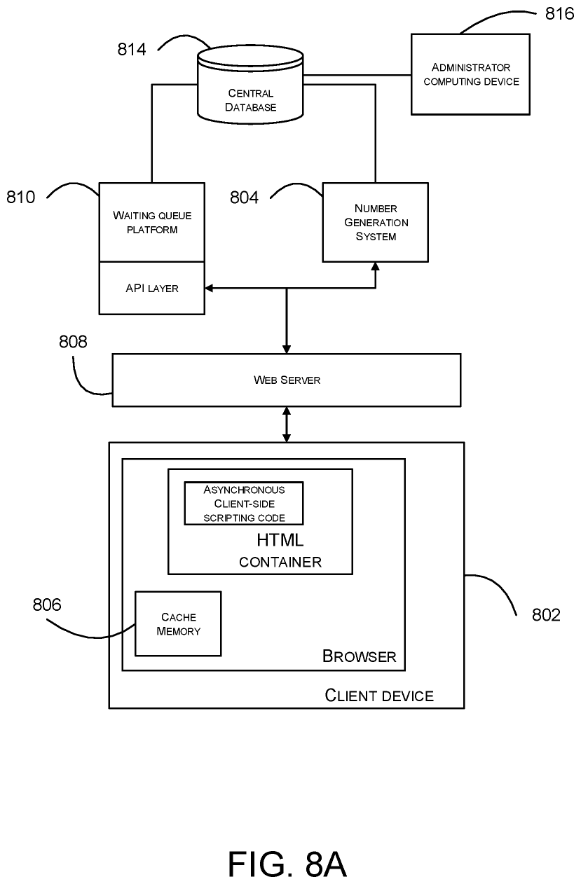

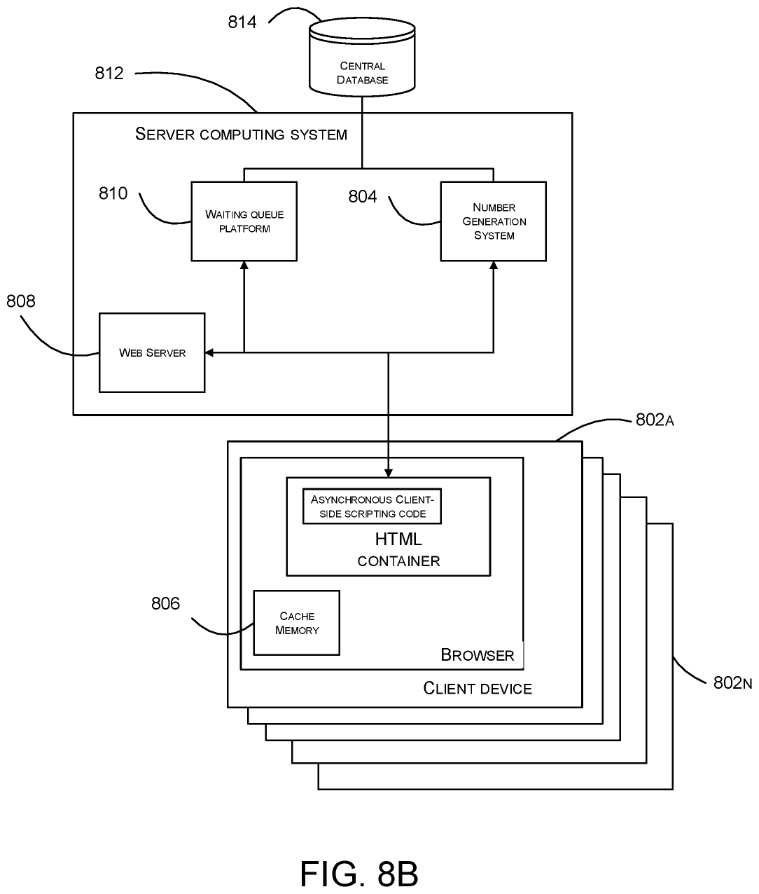

### FIG. 8A and FIG. 8B

FIGS. 8A and 8B illustrate examples of network configurations of various systems interacting in accordance with certain aspects of the disclosure. While the disclosure contemplates numerous different approaches to implementing the disclosed system, in one example, the system may be implemented through server-side components, client-side components, and objects. For example, see FIG. 8A, which illustrates just one example of a sample network configuration of the components/modules/systems interacting. Other configurations and interactions are contemplated (e.g., see FIG. 8B) and the illustration of FIG. 8A is not meant to be limiting. Aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the invention.

In various examples, the apparatuses/systems described herein may enable methods/processes that perform one or more of the following steps:

First, a method comprising one or more of the following steps: when a ticket object is generated, the client-side Javascript sends an AJAX call to a web server 808 to determine the quantity of ticket objects and/or lines of combinations are presently marked in the central database 814 (or persistent cache of the database) with a “pending” status as explained with respect to FIG. 7B. The client device 802 may include a cache memory 806 that may be used to store the ticket object locally. For example, the ticket object may be stored in the cache memory 806 until the ticket object is processed. If the aforementioned inquiry results in a quantity greater than one, then the graphical user interface of the user's device may display the quantity to indicate to the user the number of other users and/or lines of combos that are being viewed for potential purchase. This graphical indicator may be useful for users/players to inform them that they are not the only ones viewing the combinations displayed and/or that they risk losing that exact set if someone else checks out faster than they do. In some examples, the user would be subjected to whatever combinations are left in their ticket object.

In some embodiments, the administrator computing device 816 shown in FIG. 8A may be configured to access the central database 814 which may be accessed via the server computing system 812 (e.g., a server computing system which may include any of the features and/or capabilities of the server computing system 712 that is depicted in FIGS. 7A-C). The waiting queue platform 810 (e.g., a ticket queue) may be used to store ticket objects. The number generation system 804 may include a random number generator that is used to generate random numbers and/or random combinations of numbers for inclusion in ticket objects. Further, the administrator computing device 816 may have authorization to make one or more changes to the contents of the central database 814 including changing the ticket array stored in the central database 814 and/or any of the plurality of combinations of numbers that are included in the ticket array (e.g., any of the combinations of numbers that were selected at the time of the draw). For example, in the event that a portion of the plurality of combinations of numbers in the ticket array is still available at the time of the draw the administrator computing device 816 may remove any of the combinations of numbers that were not selected from the plurality of combinations of numbers in the ticket array that are available to be drawn (e.g., the plurality of combinations of numbers that were not selected). Further, the administrator computing device 816 may be configured to provide an indication of the portion of the plurality of combinations of numbers that were not selected (e.g., the indication 406 shown in FIG. 4). In this way, in the event that every plurality of combinations of numbers in the ticket array has not been selected at the time of the draw, only the plurality of combinations of numbers that were selected may be drawn. As such, each draw will include a winning combination of numbers.

Finally, this disclosure contemplates and discloses a non-transitory computer-readable storage medium having computer-executable program instructions stored thereon that when executed by a processor, cause the processor to perform one or more of the method steps described above. Moreover, this disclosure contemplates and discloses an apparatus comprising: (1) a processor, and (2) a memory having stored therein computer executable instructions, that when executed by the processor, cause the apparatus to perform one or more of the method steps described above.

What is claimed is:

1. A computer-implemented method of queuing and processing ticket objects associated with combinations of numbers to enforce a process of elimination for a ticket event, the computer-implemented method comprising:
generating, by a server computing system comprising one or more processors, a ticket array based on parameters of the ticket event, wherein the ticket array comprises a plurality of combinations of numbers consisting of a plurality of combinations of processed numbers for the ticket event and a plurality of combinations of unprocessed numbers for the ticket event;
receiving, by the server computing system, and from a client computing device, a ticket object associated with the ticket event, wherein the ticket object comprises a combination of selected numbers;
adding, by the server computing system, the ticket object to a ticket queue that is configured to hold the ticket object before the ticket object is processed;
determining, by the server computing system, whether the ticket object meets ticket criteria comprising a ticket criterion associated with a uniqueness of the combination of selected numbers for the process of elimination for the ticket event;
in response to the ticket object meeting at least one of the ticket criteria, processing, by the server computing system, the ticket object, wherein the processing comprises:
determining whether one or more queue locking criteria have been met, wherein the one or more queue locking criteria comprises a threshold number of ticket objects;
in response to determining that at least one of the one or more queue locking criteria have been met, locking the ticket queue, wherein the locking the ticket queue prevents any ticket object from being added to the ticket queue until one or more queue unlocking conditions have been met;
updating the ticket array with the combination of selected numbers, wherein the updating comprises storing the combination of selected numbers in the ticket array;
updating the ticket object to indicate that the ticket object can be removed from the ticket queue;
determining whether one or more queue unlocking conditions have been met, wherein the one or more queue unlocking conditions comprise a rate of adding ticket objects to the ticket queue being below a rate threshold;
in response to at least one of the one or more queue unlocking conditions being met, unlocking the ticket queue after updating the ticket object;
generating, by the server computing system, a notification after the ticket object has been processed; and
sending, by the server computing system, the notification to the client computing device.

2. The computer-implemented method of claim 1, wherein the updating the ticket array with the combination of selected numbers, wherein the updating comprises storing the combination of numbers in the ticket array comprises:
determining, by the server computing system, whether the combination of selected numbers matches any of the plurality of combinations of processed numbers; and
in response to the combination of selected numbers not matching any of the plurality of combinations of processed numbers, adding, by the server computing system, the combination of selected numbers to the ticket array.

3. The computer-implemented method of claim 2, further comprising:
in response to the combination of selected numbers matching any of the plurality of combinations of processed numbers, replacing, by the server computing system, one or more of the combination of selected numbers until the combination of selected numbers does not match any of the plurality of combinations of processed numbers.

4. The computer-implemented method of claim 3, wherein the replacing, by the server computing system, one or more of the combination of selected numbers until the combination of selected numbers does not match any of the plurality of combinations of processed numbers comprises:
generating, by the server computing system, one or more randomly generated numbers; and
replacing, by the server computing system, one or more of the combination of selected numbers with the one or more randomly generated numbers.

5. The computer-implemented method of claim 4, wherein the one or more randomly generated numbers are based at least in part on a random seed that is based at least in part on the ticket event and a state of the server computing device comprising a current time.

6. The computer-implemented method of claim 1, wherein the processing, by the server computing system, the ticket object comprises:
removing, by the server computing system, the ticket object from the ticket queue after the ticket object has been processed; or
removing, by the server computing system, the ticket object from the ticket queue when the ticket criteria have not been met for greater than a predetermined amount of time.

7. The computer-implemented method of claim 1, wherein the one or more queue locking criteria comprise a ticket event deadline occurring or a rate of adding ticket objects to the ticket queue exceeding a rate threshold.

8. The computer-implemented method of claim 1, wherein the one or more queue unlocking conditions comprise a predetermined amount of time elapsing or a number of ticket objects in the ticket queue being below a ticket threshold.

9. The computer-implemented method of claim 1, wherein the adding, by the server computing system, the ticket object to a ticket queue that is configured to hold the ticket object before the ticket object is processed comprises:
generating, by the server computing system, a timestamp for the ticket object; and
arranging, by the server computing system, the ticket object in the ticket queue based at least in part on the time stamp, wherein the ticket object is placed ahead of any other ticket objects that are associated with the ticket event and have a more recent timestamp, and wherein the ticket object is placed behind any other ticket objects that are associated with the ticket event and have an older timestamp.

10. The computer-implemented method of claim 1, further comprising:
receiving, by the client computing device, one or more user inputs comprising information associated with the ticket object;
generating, by the client computing device, the ticket object based at least in part on the one or more user inputs; and
sending, by the client computing device, the ticket object to the server computing system.

11. The computer-implemented method of claim 10, wherein the client computing device uses a synchronous communication protocol to send the ticket object to the server computing system.

12. The computer-implemented method of claim 10, wherein the one or more user inputs correspond to the combination of selected numbers.

13. The computer-implemented method of claim 10, wherein the one or more user inputs correspond to payment data comprising a payment account and authorization to access a user determined amount from the payment account, and further comprising:
generating, by the client computing device, the ticket object based at least in part on the payment data, wherein the ticket criteria comprise the ticket object comprising the payment data.

14. The computer-implemented method of claim 10, wherein the client computing device is a mobile computing device, and wherein the one or more user inputs are received via a graphical user interface of the client computing device.

15. One or more non-transitory computer readable media comprising instructions that, when executed by at least one processor, cause a computing device to perform operations comprising:
generating a ticket array based on parameters of a ticket event, wherein the ticket array comprises a plurality of combinations of numbers consisting of a plurality of combinations of processed numbers for the ticket event and a plurality of combinations of unprocessed numbers for the ticket event;
receiving from a client computing device, a ticket object associated with the ticket event, wherein the ticket object comprises a combination of selected numbers;
adding the ticket object to a ticket queue that is configured to hold the ticket object before the ticket object is processed;
determining whether the ticket object meets ticket criteria comprising a ticket criterion associated with a uniqueness of the combination of selected numbers for a process of elimination for the ticket event;
in response to the ticket object meeting at least one of the ticket criteria, processing the ticket object, wherein the processing comprises:
determining whether one or more queue locking criteria have been met, wherein the one or more queue locking criteria comprises a threshold number of ticket objects;
in response to determining that at least one of the one or more queue locking criteria have been met, locking the ticket queue, wherein the locking the ticket queue prevents any ticket object from being added to the ticket queue until one or more queue unlocking conditions have been met;
updating the ticket array with the combination of selected numbers, wherein the updating comprises storing the combination of selected numbers in the ticket array;
updating the ticket object to indicate that the ticket object can be removed from the ticket queue;
determining whether one or more queue unlocking conditions have been met, wherein the one or more queue unlocking conditions comprise a rate of adding ticket objects to the ticket queue being below a rate threshold;
in response to at least one of the one or more queue unlocking conditions being met, unlocking the ticket queue after updating the ticket object;
generating a notification after the ticket object has been processed; and
sending the notification to the client computing device.

16. The one or more non-transitory computer readable media of claim 15, wherein the instructions comprising determining whether the ticket object meets ticket criteria associated with a uniqueness of the combination of selected numbers, when executed by at least one processor, cause a computing device to perform operations comprising:
determining that the ticket criteria have not been met when a number of the plurality of combinations of processed numbers in the ticket array equal or exceed the plurality of combinations of unprocessed numbers.

17. The one or more non-transitory computer readable media of claim 15, wherein the instructions to process the ticket object, when executed by the at least one processor, cause the computing device to perform operations further comprising:
in response to the combination of selected numbers matching at least one of the plurality of combinations of processed numbers, determining the plurality of combinations of processed numbers that have the lowest Jaccard distance relative to the combination of selected numbers; and
replacing one or more numbers of the combination of selected numbers until the combination of selected numbers does not match any of the plurality of combinations of processed numbers.

18. A computing system comprising:
one or more processors; and
memory storing instructions that, when executed by the one or more processors, cause the computing system to:
generate a ticket array based on parameters of a ticket event, wherein the ticket array comprises a plurality of combinations of numbers consisting of a plurality of combinations of processed numbers for the ticket event and a plurality of combinations of unprocessed numbers for the ticket event;
receive from a client computing device, a ticket object associated with the ticket event, wherein the ticket object comprises a combination of selected numbers;
add the ticket object to a ticket queue that is configured to hold the ticket object before the ticket object is processed;
determine whether the ticket object meets ticket criteria comprising a ticket criterion associated with a uniqueness of the combination of selected numbers for a process of elimination for the ticket event;
in response to the ticket object meeting at least one of the ticket criteria, process the ticket object, wherein the processing comprises:
determine whether one or more queue locking criteria have been met, wherein the one or more queue locking criteria comprises a threshold number of ticket objects;
in response to determining that at least one of the one or more queue locking criteria have been met, lock the ticket queue, wherein the locking the ticket queue prevents any ticket object from being added to the ticket queue until one or more queue unlocking conditions have been met;
update the ticket array with the combination of numbers, wherein the updating comprises storing the combination of numbers in the ticket array;
update the ticket object to indicate that the ticket object can be removed from the ticket queue;
determine whether one or more queue unlocking conditions have been met, wherein the one or more queue unlocking conditions comprise a rate of adding ticket objects to the ticket queue being below a rate threshold;
in response to at least one of the one or more queue unlocking conditions being met, unlock the ticket queue after updating the ticket object;
generate a notification after the ticket object has been processed; and
send the notification to the client computing device.

19. The computing system of claim 18, wherein the ticket object comprises one or more lines, and wherein at least one of the one or more lines correspond to the combination of selected numbers.

20. The computing system of claim 18, wherein the ticket array comprises a plurality of processed hash values corresponding to the plurality of combinations of processed numbers that were hashed using a hash function, and wherein the instructions to determine whether the ticket object meets ticket criteria associated with a uniqueness of the combination of selected numbers comprise:
generating, based at least in part on the combination of selected numbers and the hash function, a hashed ticket value;
comparing the hashed ticket value to the plurality of processed hash values; and
in response to the hashed ticket value matching any of the plurality of processed hash values, generating a notification comprising an indication that the combination of selected numbers is not unique.
